(19) United States
(12) Patent Application Publication
(10) Pub. No.: US 2010/0012552 A1
(43) Pub. Date: Jan. 21, 2010

(54) PROCESS AND APPARATUS FOR PRODUCING GASOLINE

(76) Inventors: Robert B. James, JR., Northbrook, IL (US); Deng-Yang Jan, Elk Grove Village, IL (US); Robert J. Schmidt, Barrington, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/176,290

(22) Filed: Jul. 18, 2008

(51) Int. Cl. C10G 59/00; B01J 19/00

(52) U.S. Cl. 208/64; 422/188

(57) ABSTRACT

One exemplary embodiment can be a process for producing a gasoline. The process can include contacting a feed having a naphtha and recycling at least a portion of the reaction zone effluent to the one or more reforming reaction zones. Generally, the reformate includes no more than about 15%, by volume, benzene, with a UZM-8 catalyst in one or more reforming reaction zones to produce a reaction zone effluent.

### FIELD OF THE INVENTION

This invention generally relates to an apparatus and a process for producing a gasoline.

### DESCRIPTION OF THE RELATED ART

In recent years, environmental laws and regulations have limited the amount of benzene that is permissible in petroleum motor fuels. These regulations have produced substantial changes in refinery operation. In addition, it is expected in the future that these requirements will only become stricter. As a result, it is desirable for refiners to find a way to reduce benzene levels in gasoline.

### SUMMARY OF THE INVENTION

One exemplary embodiment can be a process for producing a gasoline. The process can include contacting a feed having a naphtha and recycling at least a portion of the reaction zone effluent to the one or more reforming reaction zones. Generally, the reformate includes no more than about 15%, by volume, benzene, with a UZM-8 catalyst in one or more reforming reaction zones to produce a reaction zone effluent.

Another exemplary embodiment may be an apparatus for producing a gasoline. The apparatus can include a fractionation zone, one or more reforming reaction zones, and a heat exchange zone. Generally, the fractionation zone separates a reformate into a first product and a second product. Usually, the one or more reforming reaction zones include a UZM family molecular sieve and receives a feed, which may include a stream having one or more olefins and the first product. The one or more reforming reaction zones can produce a reaction zone effluent. Generally, a heat exchange zone cools a portion of the reaction zone effluent that is recycled and comprised in the feed to the one or more reforming reaction zones.

A further embodiment can be a process for producing a gasoline. The process can include contacting a feed with a UZM-8 catalyst at a temperature of about 38-about 230° C., an absolute pressure of about 3,000-about 7,000 kPa, and LHSV of about 1-about 15 hr⁻¹. Generally, the feed includes a reformate having no more than about 4%, by volume, benzene, a stream comprising one or more olefins, and a recycled reaction zone effluent; and has an olefin:benzene mole ratio of about 1:1-about 2.5:1.

Generally, the embodiments herein utilize a UZM family molecular sieve with a feed stream having sufficient olefin content to react with benzene in the stream. Using the UZM-8 family molecular sieve can promote a reaction between the benzene and the olefin to alkylate or multi-alkylate benzenes. The resulting alkylated benzene products can be removed from the reaction product. As such, this catalyzed process can make reducing benzene in fuel economical.

### DEFINITIONS

As used herein, the term “reformate” refers to a substance that is a gasoline product, a substance comprised in a gasoline product, or a substance not having insubstantial, i.e., at least 30%, by weight, of gasoline components. Typically, a reformate is a hydrocarbon containing one or more components with a 95% point range determined by 2007 ASTM 86 of about 150-about 220° C., preferably about 160-about 180° C., and may include light and heavy reformates. In addition, the term “reformate” may include at least a portion of a naphtha prior to reacting in a reforming reaction zone, along with at least a portion of a reforming reaction zone effluent. As such, the term “reformate” may be used to indicate a substance before entering and after exiting a reforming reaction zone.

As used herein, the term “feed” can include a reformate, an olefin stream, and/or a recycle of a reforming reaction zone effluent. A reforming reaction zone effluent does not exclude a reaction zone having another effluent or a plurality of zones having respective one or more effluents.

### BRIEF DESCRIPTION OF THE DRAWINGS

FIG. 1 is a schematic depiction of an exemplary apparatus.

FIG. 2 is a schematic depiction of another exemplary apparatus.

### DETAILED DESCRIPTION

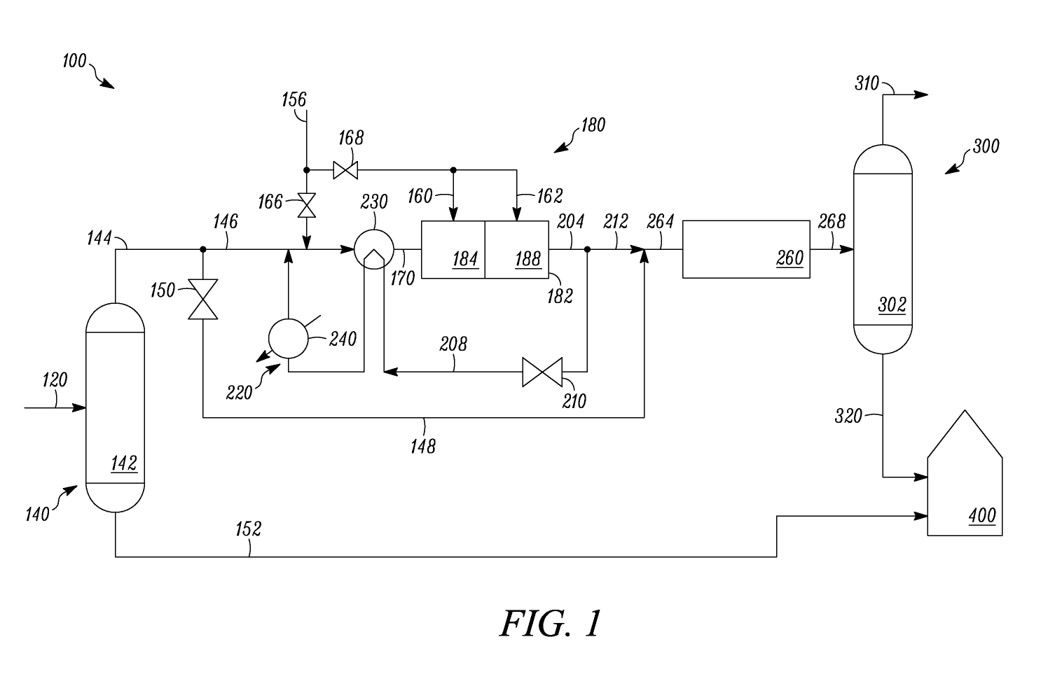

Referring to FIG. 1, an apparatus 100 for removing benzene from a reformate stream 120 can include a fractionation or a first fractionation zone 140, a heat exchange zone 220, one or more reforming reaction zones 180, an optional trans-alkylation zone 260, a further or second fractionation zone 300, and a product storage 400.

Generally, the first fractionation zone 140 can include a distillation column 142. Typically, the distillation column 142 receives a charge of the reformate stream 120 including no more than about 15, about 12, about 10, about 5, about 4, about 2, or about 1 percent benzene by volume. This charge can be split into a first, top product 144, typically a light reformate, and a second, bottom product 152, typically a heavy reformate. The top product 144 can contain substantial amounts of benzene as compared to the small amounts of toluene, ethyl benzene, and xylene.

The bottom product 152 can be sent directly to the product storage 400, which can include one or more product storage tanks in a tank farm. Generally, the bottom product 152 tends to have very little benzene, e.g., less than 1%, by volume.

The top product 144 can be split into a first portion 146 and optionally a second portion 148. The second portion 148 may bypass the one or more reforming reaction zones 180 by at least partially opening a valve 150. Preferably, the valve 150 permits throttling to split the top product 144. Alternatively, the valve 150 can be closed and the entire top product 144 can be comprised in the first portion 146.

Afterwards, the first portion 146 may be combined with several other streams. Particularly, a reforming reaction zone effluent recycle 208, which will be described in further detail hereinafter, can be combined with the first portion 146. In addition, a stream including one or more olefins 156 can be provided through a valve 166, which is preferably a control valve. Alternatively, if the first portion 146 and/or the reforming reaction zone effluent recycle 208 have sufficient amounts of olefin, an olefin stream 156 may be omitted and not combined with the first portion 146.

The stream including one or more olefins 156 can include C2-C7 olefins, preferably C2-C4 olefins. The olefin stream 156 can contain anywhere from about 2-about 100%, by weight, preferably at least about 20%, by weight, and optimally at least about 35%, by weight, olefins. The balance of the olefin stream can be other hydrocarbons, such as other C2-C7 hydrocarbons, particularly paraffins.

Afterwards, the combined streams can pass through the heat exchange zone 220, which includes a feed/recycle heat exchanger 230 and a cooling water exchanger 240, which will be described hereinafter. Generally, the combined streams only pass through the feed/recycle heater exchanger 230. Subsequently, this feed 170 can enter the one or more reforming reaction zones 180. Desirably, the feed has an olefin:benzene mole ratio of about 1:1-about 2.5:1, preferably about 1.2-about 2.0:1.

In this exemplary environment, the one or more reforming reaction zones 180 can include a plurality of reaction zones 180, such as a reactor 182 containing a first zone 184 and a second zone 188. Exemplary conditions can be disclosed in, e.g., U.S. Pat. No. 7,268,267 B2. In the one or more reforming reaction zones 180, desirably, the temperature is about 38-about 230° C., preferably about 50-about 220° C., and optimally about 60-about 180° C. The absolute pressure can be about 3,000-about 7,000 kPa, preferably about 3,500-about 7,000 kPa. Generally, the liquid hourly space velocity (may be referred to as “LHSV”) may be about 1-about 15 hr⁻¹, and the weight hourly space velocity (may be referred to as “WHSV”) may be about 1-about 30 hr⁻¹. The WHSV can be calculated as follows:

WHSV=LHSV*(Feed Density)/(Catalyst Density)

Typically, the reaction is exothermic and the temperature rise can be controlled by recycling a part of the reforming reaction zone effluent 204. This part can be the reaction zone effluent recycle 208. The reaction zone effluent recycle 208 can include both reactor species and inert species with a majority inert species. As a result, cooling the reaction zone effluent recycle 208 in the heat exchange zone 220 can be used as a quench for stage cooling of the reactor 182 or used in one zone to limit the temperature rise across the reactor 182.

Desirably, the reaction zone 180 contains a catalyst having a UZM family molecular sieve (may also be referred to as a UZM catalyst). Particularly, the UZM family molecular sieve can be used as a support or a catalyst, and can include a molecular sieve UZM-8 as disclosed in U.S. Pat. No. 6,756,030 B1 and/or a molecular sieve UZM-8HS as disclosed in US 2004/0182744 A1.

An exemplary UZM-8 molecular sieve or microporous crystalline zeolite can have the empirical formula:

Rᵣ^{p+}Al₁₋ₓEₓSi_{y}O_{z}

where R can be at least one organoammonium cation selected from protonated amines, protonated diamines, quaternary ammonium ions, diquaternary ammonium ions, protonated alkanolamines and quaternized alkanolammonium ions. A preferred organoammonium cation is one that is non-cyclic or does not contain a cyclic group as one substituent. Especially preferred may be an organoammonium cation containing at least two methyl groups as substituents. An example of a preferred cation may include DEDMA, ETMA, HM, or a mixture thereof. The ratio of R to (Al+E) may be represented by “r” which can vary from about 0.05-about 5. The value of “p”, which may be the weighted average valence of R, can vary from about 1-about 2. The ratio of Si to (Al+E) as represented by “y” can vary from about 6.5-about 35. E can be an element, which may be tetrahedrally coordinated, can be present in the framework, and can be gallium, iron, chromium, indium or boron. The mole fraction of E may be represented by “x” and can have a value from 0-about 0.5, while “z” is the mole ratio of 0 to (Al+E) and can be given by the equation:

z=(r·p+3+4·y)/2

Generally, the UZM family of molecular sieves can be utilized to react olefins, such as C2-C7 olefins with an aromatic ring, such as benzene, to form an alkylated benzene. Thus, the benzene can be eliminated from the gasoline, but at substantially the same octane number. Typically, the utilization of a UZM-8 family molecular sieve can provide a zeolitic-based process to reduce benzene in gasoline due to the catalyst's high stability under a high olefin and a low benzene concentration.

Generally, it is desirable to increase the olefin/benzene ratio to increase alkylation to reduce the amount of benzene in the reactor effluent. Increasing the amount of olefin can also increase the production of higher alkylated compounds, which may not serve as a good gasoline component, but may be more easily separated from the reactor effluent by fractionation. Other reaction parameters can be changed, such as the reactor temperature, to increase the conversion of benzene. However, this increase in temperature may also increase alkylation of the benzene molecules. To prevent the over-production of alkylated benzene compounds, limiting the conversion per pass of benzene can reduce the production of such high-boiling materials, which can be quantified by a procedure, such as ASTM 86-07.

The reforming reaction zone effluent 204 can be produced by the one or more reforming reaction zones 180. A portion of the reforming reaction zone effluent 204 can be provided as the reforming reaction zone effluent recycle 208. Generally, the reforming reaction zone effluent recycle 208 can be cooled by passing through the heat exchange zone 220, particularly the feed/recycle heat exchanger 230 and optionally, if desired, the cooling water heat exchanger 240. The reaction zone effluent recycle 208 can be combined with the first portion 146 and the stream including one or more olefins 156 as described-above. The apparatus 100 can also include a control valve 210 to control the amount of the reaction zone effluent recycle 208 to control the temperatures within the reactor 182.

Afterwards, another portion 212 of the reforming reaction zone effluent 204 can optionally be combined with a second portion 148, if such a portion 148 is bypassed around the one or more reforming reaction zones 180. This second portion 148 can be bypassed around the one or more reforming reaction zones 180, optionally depending upon the presence of the trans-alkylation zone 260. Typically, if the trans-alkylation zone 260 is included, then it may be desirable to remove the second portion 148 from the top product 144 and bypass it around the one or more reforming reaction zones 180 to provide a feed 264 of benzene and multi-alkylated benzene. In such an instance, the second portion 148 can be combined with another portion of the reaction effluent 212 to provide a feed 264 to the trans-alkylation zone 260.

In the trans-alkylation zone 260, the feed 264 can be contacted with a trans-alkylation catalyst under trans-alkylation conditions. Preferably, the catalyst is a metal stabilized trans-alkylation catalyst. Such a catalyst can include a solid-acid component, a metal component, and an inorganic oxide component. The solid-acid component typically is a pentasil zeolite, which may include the structures of MFI, MEL, MTW, MTT and FER (IUPAC Commission on Zeolite Nomenclature), a beta zeolite, or a mordenite. Desirably, it is a mordenite zeolite. Other suitable solid-acid components can include mazzite, NES type zeolite, EU-1, MAPO-36, MAPSO-31, SAPO-5, SAPO-1, and SAPO-41. Generally, mazzite zeolites include Zeolite Omega. Further discussion of the Zeolite Omega, and NU-87, EU-1, MAPO-36, MAPSO-31, SAPO-5, SAPO-11, and SAPO-41 zeolites is provided in U.S. Pat. No. 7,169,368 B1.

Typically, the metal component is a noble metal or base metal. The noble metal can be a platinum-group metal of platinum, palladium, rhodium, ruthenium, osmium, or iridium. Generally, the base metal is rhenium, tin, germanium, lead, cobalt, nickel, indium, gallium, zinc, uranium, dysprosium, thallium, or a mixture. The base metal may be combined with another base metal or with a noble metal. Suitable metal amounts in the trans-alkylation catalyst generally range from about 0.01-about 10%, preferably range from about 0.1-about 3%, and optimally range from about 0.1-about 1%, by weight. Suitable zeolite amounts in the catalyst range from about 1-about 99%, preferably from about 10-about 90%, and optimally from about 25-about 75%, by weight. The balance of the catalyst can be composed of a refractory binder or matrix that is optionally utilized to facilitate fabrication, provide strength, and reduce costs. The binder should be uniform in composition and relatively refractory. Suitable binders can include inorganic oxides, such as at least one of alumina, magnesia, zirconia, chromia, titania, boria, thoria, phosphate, zinc oxide and silica. Preferably, alumina is a binder. One exemplary trans-alkylation catalyst is disclosed in U.S. Pat. No. 5,847,256.

Usually, the trans-alkylation zone 260 operates at a temperature of about 200-about 540° C. and a pressure of about 690-about 4,140 kPa. The trans-alkylation reaction can be effected over a wide range of space velocities, with higher space velocities effecting a higher ratio of para-xylene at the expense of conversion. Generally, the LHSV is in the range of about 0.1-about 20 hr⁻¹. The feedstock is preferably trans-alkylated in the vapor phase and in the presence of hydrogen. If trans-alkylated in the liquid phase, then the presence of hydrogen is optional. If present, free hydrogen can be associated with the feedstock and recycled hydrocarbons in an amount of about 0.1 moles-up to about 10 moles per mole of an alkylaromatic. Exemplary trans-alkylation zones are disclosed in U.S. Pat. No. 6,740,788 B1; U.S. Pat. No. 7,169,368 B1; and U.S. Pat. No. 7,268,267 B2.

A trans-alkylation effluent 268 can pass to the further or second fractionation zone 300. The further or second fractionation zone 300 can include a distillation column 302 that can produce a first, light product 310 and a second, heavy product 320. The heavy product 320 can be sent to the product storage 400 while the light product 310 having higher boiling compounds can be used as feedstock for other processes or products other than gasoline. Typically, the heavy product 320 can contain less than about 1 percent, by volume, benzene. The product storage 400 can hold the final gasoline product or include several tanks for blending reformate into a final gasoline product.

In an additional embodiment, the apparatus 100 may also provide a further flexibility by allowing the splitting of the stream including one or more olefins 156. Particularly, the valve 166 can be closed and the valve 168 can be opened to permit the division of the stream 156 into a first stream 160 and a second stream 162. The first stream 160 and the second stream 162 can be fed into, respectively, the first zone 184 and the second zone 188. This can provide additional benefits of providing improved catalyst stability and possibly lowering the production of undesirable heavy oligomers and heavy aromatic compounds.

Thus, in operation, several alternative processing schemes can be utilized to remove benzene. Usually, it is desirable to remove as much benzene from the process while still minimizing the amount of higher-boiling compounds, i.e. multi-alkylated benzene compounds. Typically these higher-boiling compounds boil significantly over about 215° C. Thus, controlling certain aspects of the process can minimize the production of higher boiling compounds while still removing benzene. These process controls can include:
controlling the olefin-to-benzene ratio by adjusting the relative flow rates of the top product 144 and a stream including one or more olefins 156,
adjusting the reactor 182 inlet temperatures by heat exchangers 230 and/or 240,
adjusting the reactor outlet temperatures by controlling the reaction zone effluent recycle 208, and/or
optionally providing the trans-alkylation zone 260 that can promote the reaction between benzene and multi-alkylated benzene to form mono-alkylated benzene.
   This last option can be assisted by bypassing the second portion 148 around the one or more reforming reaction zones 180. Any of these controls can be used either individually or together in any combination.

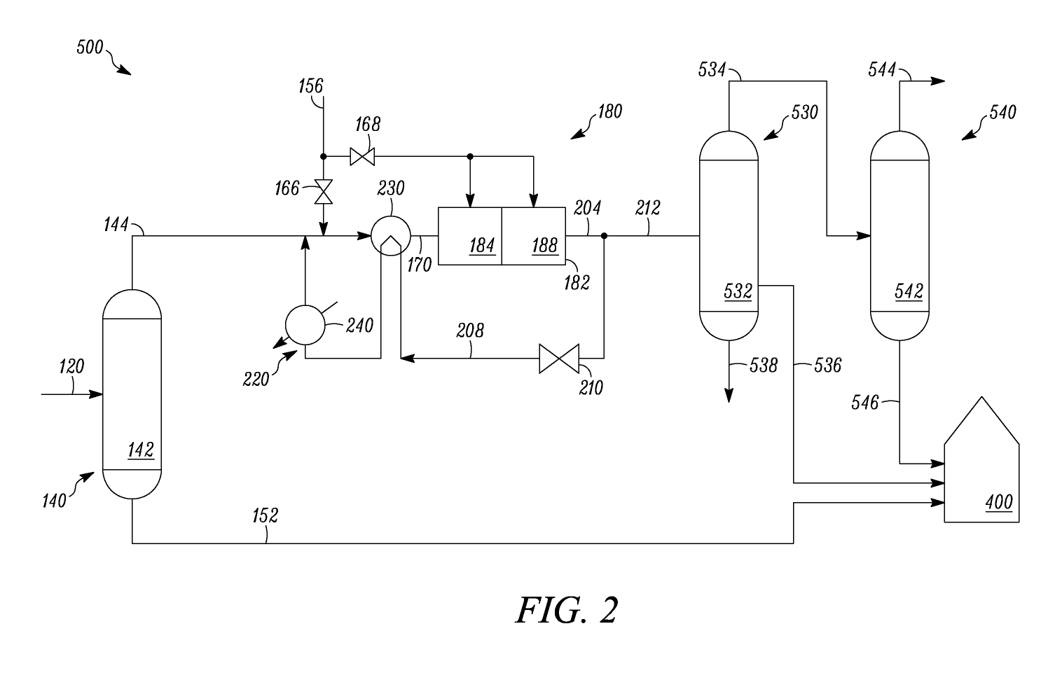

Referring to FIG. 2, another exemplary apparatus 500 is depicted. The apparatus 500 can include the fractionation zone 140, the heat exchange zone 220, and the one or more reforming reaction zones 180 as discussed previously in the apparatus 100. However, the apparatus 500 can omit the second portion 148, the valve 150, and the trans-alkylation zone 260. Instead, the reaction zone effluent 204 can provide another portion of the reaction zone effluent 212 to be a feed to a further or second fractionation zone 530. The further or second fractionation zone 530 can include a distillation column 532 providing a first, light product 534, a second, intermediate product 536, and a third, heavy product 538. The third heavy product 538 can include multi-alkylated benzene compounds and be removed at the bottom of the distillation column 532. The intermediate product 536 can include a gasoline product and be sent directly to product storage 400. The first light product 534 can be sent to a still further or third fractionation zone 540. The third fractionation zone 540 can include a distillation column 542 providing a first, light product 544 and a second, heavy product 546. The heavy product 546 can be sent to product storage 400 and be utilized for gasoline, while the light product 544 can be sent to other possible destinations and includes light ends that can be used in other processes, including a fuel gas.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth uncorrected in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A process for producing a gasoline, comprising:
A. contacting a feed comprising a naphtha, wherein the reformate comprises no more than about 15%, by volume, benzene, with a UZM-8 catalyst in one or more reforming reaction zones to produce a reaction zone effluent; and
B. recycling at least a portion of the reaction zone effluent to the one or more reforming reaction zones.

2. The process according to claim 1, further comprising, before contacting the feed, combining a stream comprising one or more olefins with the reformats.

3. The process according to claim 2, further comprising controlling the olefin to benzene ratio in the feed by regulating the amount of the olefin stream.

4. The process according to claim 3, wherein the one or more olefins comprises at least one of a C2-C7 olefin.

5. The process according to claim 3, wherein the one or more olefins comprises at least one of a C2-C4 olefin.

6. The process according to claim 3, wherein the olefin stream comprises about 2-about 100%, by weight, olefin based on a weight of the olefin stream.

7. The process according to claim 1, further comprising cooling the reaction zone effluent recycle wherein the feed comprises the reformate, a stream comprising one or more olefins, and the reaction zone effluent recycle.

8. The process according to claim 1, wherein the contacting is conducted at a temperature of about 38-about 230° C., an absolute pressure of about 3,000-about 7,000 kPa, and WHSV of about 1-about 30 hr⁻¹.

9. The process according to claim 8, wherein the feed comprises an olefin:benzene mole ratio of about 1:1-about 2.5:1.

10. The process according to claim 1, wherein the reformate has a 95% point determined by ASTM 86-07 of about 150-about 220° C.

11. The process according to claim 1, further comprising adjusting the recycle to control a reaction zone outlet temperature.

12. The process according to claim 1, further comprising trans-alkylating another portion of the reaction zone effluent comprising benzene and multi-alkylated benzene to form mono-alkylated benzene.

13. The process according to claim 1, further comprising fractionating the reaction zone effluent.

14. The process according to claim 2, further comprising splitting the stream comprising one or more olefins into a plurality of streams to communicate with a plurality of reaction zones.

15. An apparatus for producing a gasoline, comprising:
A. a fractionation zone separating a reformate into a first product and a second product;
B. one or more reforming reaction zones comprising a UZM family molecular sieve and receiving a feed, wherein the feed comprises a stream comprising one or more olefins and the first product, and produces a reaction zone effluent; and
C. a heat exchange zone for cooling a portion of the reaction zone effluent that is recycled and comprised in the feed to the one or more reforming reaction zones.

16. The apparatus according to claim 15, further comprising a further fractionation zone for receiving another portion of the reaction zone effluent and separating a first product and a second product comprising the gasoline with a reduced benzene content.

17. The apparatus according to claim 15, wherein the gasoline comprises less than about 1%, by volume, benzene.

18. The apparatus according to claim 15, further comprising a trans-alkylation zone communicating with the one or more reforming reaction zones to receive another portion of the reaction zone effluent.

19. The apparatus according to claim 16, wherein the further fractionation zone further separates a third product.

20. A process for producing a gasoline, comprising:
A. contacting a feed with a UZM-8 catalyst at a temperature of about 38-about 230° C., an absolute pressure of about 3,000-about 7,000 kPa, and WHSV of about 1-about 30 hr⁻¹;
wherein the feed comprises a reformate comprising no more than about 4%, by volume, benzene, a stream comprising one or more olefins, and a recycled reaction zone effluent; and has an olefin:benzene mole ratio of about 1:1-about 2.5:1.
